(19) United States
(12) Patent Application Publication
(10) Pub. No.: US 2008/0145632 A1
(43) Pub. Date: Jun. 19, 2008

(54) Window Material for Display

(75) Inventor: Satoru Nagami, Kanagawa (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: MITSUI CHEMICALS, INC., Minato-ku, Tokyo (JP)

(21) Appl. No.: 11/720,004

(22) PCT Filed: Nov. 24, 2005
(86) PCT No.: PCT/JP05/21533

§ 371 Date: May 23, 2007

(30) Foreign Application Priority Data
Nov. 26, 2004 (JP) 2004-342869

(51) Int. Cl. B32B 27/36

(52) U.S. Cl. 428/220; 428/412; 428/480

(57) ABSTRACT

The invention provides a window material for a display having at least two biaxially stretched polyester sheets, one of the sheets being disposed as an outer layer of a display surface. The window material for a display has a thickness of 0.3 to 5 mm and a light transmittance of 80 to 99.5%. The window material for a display preferably has a layer of a resin other than polyester, such as polycarbonate. Further, the window material for a display has a bending strength of 50 to 100 MPa, a bending modulus of elasticity of 3000 to 5500 MPa, and a maximum impact strength in a high-speed impact test of 1 kN or more. The window material for a display of the present invention is used as a window material for a display for devices such as liquid crystal display devices (LCDs), cathode-ray tube display devices (CRTs), EL display devices, plasma display devices (PDPs), and projection display devices.

### TECHNICAL FIELD

The present invention relates to a window material for a display mainly for use in a display portion of liquid crystal display devices (LCDs), cathode-ray tube display devices (CRTs), EL display devices, plasma display devices (PDPs), projection display devices or display panels for measuring instruments. The display panel of the display is, more specifically, a window material for a display for personal computers, televisions, digital cameras, video cameras, personal data assistants (PDAs) or cellular phones.

### BACKGROUND ART

As a surface material for a display of liquid crystal display devices (LCDs), cathode-ray tube display devices (CRTs), EL display devices, plasma display devices (PDPs) or projection display devices, a panel made of an acrylic resin is currently in widespread use. While a panel made of an acrylic resin has excellent transparency, it breaks easily and thus a certain degree of thickness is required when it is used for a display panel. However, in order to meet the current trend of reducing thickness or weight of equipment, it has been necessary to reduce the thickness of the surface material for a display. To meet this requirement, use of a panel made of PC (polycarbonate) has been considered, such a panel having excellent transparency and an extremely high degree of impact strength (for example, Patent Document 1). However, the PC panel has the defect of insufficient chemical resistance, which makes it difficult to provide a hard-coating with a high degree of hardness.

On the other hand, an amorphous transparent sheet made of polyethylene terephthalate, which is a type of polyester, has been widely used since it can be molded into various shapes by punching molding. However, the material is not preferable for use as a window material for a display of portable display devices due to insufficient bending strength and surface scratch resistance. Further, although a biaxially stretched sheet made of polyester exhibits excellent transparency, elastic modulus, rigidity and the like, the thickness of the sheet is in practice limited to about 200 μm because of the capacity of stretching machines, and it is impossible to stretch the sheet to a thickness of 0.5 mm or more.

Patent Document 1: Japanese Patent Application Laid-open No. 2003-15536

### DISCLOSURE OF THE INVENTION

### Problems to be Solved by the Invention

An object of the present invention is to obtain a window material for a display having favorable transparency and excellent strength even when it has a reduced thickness, and also excellent surface scratch resistance. An object of the present invention is to obtain a window material for a display used for a device such as liquid crystal display devices (LCDs), cathode-ray tube display devices (CRTs), EL display devices, plasma display devices (PDPs), projection display devices, display panels for measuring instruments, or the like.

To solve the aforementioned objects, the present invention provides a window material for a display as shown below.

That is, the present invention relates to:

[1] A window material for a display, comprising at least two biaxially stretched polyester sheets, wherein one of the sheets is disposed as an outer layer of a display surface.
[2] The window material for a display of 1, having a thickness of from 0.3 to 5 mm.
[3] The window material for a display of 1, having a total light transmittance of from 80 to 99.5%.
[4] The window material for a display of 1, further comprising a laminated layer of a resin other than polyester.
[5] The window material for a display of 4, wherein the layer of a resin other than polyester is a polycarbonate sheet.
[6] The window material for a display of 5, wherein a biaxially stretched polyester sheet, a polycarbonate sheet and a biaxially stretched polyester sheet are laminated in this order from the outer side of the display surface.
[7] The window material for a display of 1, having a bending strength of from 50 to 100 MPa.
[8] The window material for a display of 1, having a bending modulus of elasticity of from 2,500 to 7,000 MPa.
[9] The window material for a display of 1, wherein the maximum impact strength of the window material as measured in a high-speed impact test is 1 kN or more.
[10] The window material for a display of 1, wherein the fracture morphology after impact in a high-speed impact test is ductile.
[11] The window material for a display of 1, wherein the scratch hardness as measured in a pencil hardness test (JIS-K5600-5-4:1999, 1 kg load) of the outer layer biaxially stretched polyester sheet is 2H or more.
[12] The window material for a display of 1, wherein the biaxially stretched polyester sheet is a biaxially stretched polyethylene terephthalate sheet.
[13] The window material for a display of 1, further comprising at least one layer selected from a hard coat layer; an anti-reflection layer; a polarizing layer, an infrared ray shielding layer, an anti-glare layer, an anti-static layer; an electromagnetic wave shielding layer, an anti-fogging layer and a surface protecting layer.
[14] The window material for a display of 13, wherein the hard coat layer is further disposed at a further outer side than the outer layer biaxially stretched polyester sheet.
[15] The window material for a display of 1, wherein the window material is used for a device selected from the group consisting of a liquid crystal display device (LCD), a cathode-ray tube display device (CRT), an EL display device, a plasma display device (PDP), a projection display device and a display panel for a measuring instrument.

### EFFECT OF THE INVENTION

According to the present invention, there can be provided a window material for a display having favorable transparency and excellent strength even when it has a reduced thickness, and also excellent surface scratch resistance. Furthermore, according to the present invention, there can be provided a window material for a display for use in devices such as liquid crystal display devices (LCDs), cathode-ray tube display devices (CRTs), EL display devices, plasma display devices (PDPs), projection display devices, display panels for measuring instruments, or the like.

### BEST MODE FOR CARRYING OUT THE INVENTION

The window material for a display of the present invention contains at least two biaxially stretched polyester sheets. The present invention will now be illustrated in detail.

(Biaxially Stretched Polyester Sheet)

The biaxially stretched polyester sheet according to the present invention is composed of a polyester, which can be obtained by performing condensation polymerization of a diol and a dicarboxylic acid. Representative examples of the diols include ethylene glycol, trimethylene glycol, tetramethylene glycol, cyclohexane dimethanol and the like. Meanwhile, representative examples of the dicarboxylic acids include terephthalic acid, isophthalic acid, phthalic acid, naphthalene dicarboxylic acid, adipic acid, sebacic acid and the like. Concrete examples of the polyesters according to the present invention include polymethylene terephthalate, polyethylene terephthalate, polytetramethylene terephthalate, polyethylene-p-oxybenzoate, poly-1,4-cyclohexanedimethylene terephthalate, polyethylene-2,6-naphthalate and the like. These polyesters may be either a homopolymer or a copolymer. As the component for copolymerization, for example, a diol component such as diethylene glycol, neopentyl glycol, polyalkylene glycol and the like, or a dicarboxylic acid component such as an adipic acid, a sebacic acid, a phthalic acid, an isophthalic acid, a 2,6-naphthalene dicarboxylic acid and the like can be used. Furthermore, for the purpose of improving the rigidity, a thermoplastic polyester elastomer (TPE) can be blended therewith in such an amount that the properties of the polyester are not impaired. Preferable polyesters according to the present invention include polyethylene terephthalate, polyethylene-2,6-naphthalate and polybutylene terephthalate, from the viewpoints of mechanical strength, heat resistance, chemical resistance, durability and the like. Among these, polyethylene terephthalate, which has an advantage over affordability, is most preferable.

A resin other than polyester may also be blended in the polyester according to the present invention, in such an amount that the object of the present invention is not impaired. For example, a thermoplastic polyester elastomer (TPE) can be blended with the polyester for the purpose of improving the rigidity.

Various known additives can be added to the polyester according to the present invention in such an amount that the object of the present invention is not impaired. Examples of such additives include antioxidants, antistatic agents, crystal nucleation agents, inorganic particles, organic particles, pigments and the like. Specifically, addition of the inorganic particles or organic particles is effective in view of imparting lubricity to the surface of the sheet, which improves the handleability of the sheet at the time of disposing another layer onto the sheet.

The biaxially stretched polyester sheet according to the present invention is a sheet obtained by performing biaxial stretching using the above polyester. The thickness of the sheet is usually from about 0.05 to 0.25 mm, and less than 0.3 mm even when the sheet is especially thick. When the sheet is too thick, the display panel may become so heavy that the size or weight of equipments provided with the display panel may fail to be reduced. When the sheet is too thin, the strength of the display panel may be lowered to cause breakage during use. The thickness of the sheet can be selected as appropriate according to usage.

The biaxially stretched polyester sheet according to the present invention can be obtained by the method including: supplying the pellets of the aforementioned polyester to a heated extruder; making the pellets into the form of a sheet by melt-extruding or injection molding to obtain an original polyester sheet which is substantially not oriented; and stretching the original polyester sheet in a biaxial manner. The biaxial stretching is usually carried out in the machine and transverse directions. By performing stretching, the molecules are oriented and the sheet can obtain necessary strength. The stretch ratio is usually from 2 to 20 times, preferably from 2.5 to 10 times, which can be selected as appropriate according to usage. In order to make the sheet strength uniform, the stretch ratio in the respective machine and transverse directions may be changed as appropriate.

The stretching may be carried out either before or after the lamination of the original polyester sheets, or both of before and after the lamination. The stretching may be carried out a plurality of times according to the cases. For example, a method is usually taken in which a coating agent containing a polyester is applied onto a surface of a single-layered sheet, a solvent is dried in a tenter, and the sheet is subjected to stretching and thermal treatment. However, the method is not restricted to the above and other methods can also be taken, for example: laminating the biaxially stretched polyester sheets which have been separately stretched, by heating, pressurizing or using an adhesive; laminating the sheets by co-extruding and performing stretching; or laminating the sheets by heating or using an adhesive, then performing stretching.

The window material for a display of the present invention usually includes at least two layers of the aforementioned biaxially stretched polyester sheets, preferably three or more, and the thickness, rigidity and the like that are required for a window material are provided by laminating these sheets. The window material for a display of the present invention is obtained by laminating three to ten layers of the sheets, particularly preferably four to seven layers of the sheets, from the viewpoint that the rigidity is excellent while the transparency is not impaired.

(Layer of a Resin Other than Polyester)

The window material for a display of the present invention may comprise only the aforementioned biaxially stretched polyester sheet, but the material may further has a layer of a resin other than polyester. As the layer of a resin other than polyester, various resins can be used as far as the resin can be processed into the form of a sheet, exhibit excellent transparency, and can be laminated with the biaxially stretched polyester sheet.

Specific examples of the resin other than polyester include a polycarbonate, an acrylic resin, a polyolefin resin such as polypropylene, polymethylpentene, cyclic polyolefin or the like, a polyamide resin such as nylon 6 or the like, polyacetal, polyphenylene oxide, polyether sulfone, polystyrene, polyether, polyether ketone, an epoxy resin, polyimide and the like. A laminate sheet including these resins in combination can also be used. Among these resins, polycarbonate is particularly suitable because it is excellent in transparency, rigidity and punching moldability to be described later. A laminate sheet including a polycarbonate sheet sandwiched between two or more layers of the biaxially stretched polyester sheet can be cited as one of the best embodiments of the present invention.

(Polycarbonate Sheet)

When the window material for a display of the present invention has a layer of a resin other than polyester as set forth above, preferable examples of the layer includes a polycarbonate sheet. It is preferable to use a polycarbonate, having excellent transparency and impact resistance, for a window material for a display, since any intended characters, graphics or the like can be clearly displayed on the display.

The polycarbonate sheet according to the present invention is composed of a polycarbonate, for which various known kinds of the polycarbonates can be used: for example, a reactant of a dihydric phenol with a carbonate precursor; a branched polycarbonate obtained by copolymerizing a multi-functional aromatic compound of tri-functional or more; or a polyester carbonate obtained by copolymerizing an aromatic or aliphatic di-functional carboxylic acid. These polycarbonates may be used singly or in combination.

Examples of the dihydric phenols that constitute the reactant of the dihydric phenol and a carbonate precursor include 2,2-bis(4-hydroxyphenyl)propane (bisphenol A), 1,1-bis(4-hydroxyphenyl)ethane, 1,1-bis(4-hydroxyphenyl)cyclohexane, 2,2-bis(3-methyl-4-hydroxyphenyl)propane, 2,2-bis(3,5-dimethyl-4-hydroxyphenyl)propane, bis(4-hydroxyphenyl)sulfide, bis(4-hydroxyphenyl)sulfone or the like. Among these, bisphenol A is most preferable. These dihydric phenols can be used singly or in combination of two or more.

Examples of the carbonate precursors include carbonyl halides, carbonate esters, haloformates and the like. Specific examples thereof include phosgene, diphenyl carbonate, dihaloformates of dihydric phenols and the like.

The aforementioned dihydric phenols and the carbonate precursors can usually be brought into reaction with each other, by a solution method or a melting method, to obtain a polycarbonate. As needed, a catalyst, a chain terminator or an antioxidant for the dihydric phenol or the like may be used in the reaction.

The solution method may be, for example, a method using phosgene in which the reaction is carried out in the presence of an acid-bonding agent and an organic solvent. Examples of the acid-bonding agents include an alkali metal hydroxide such as sodium hydroxide, potassium hydroxide or the like, and an amine compound such as pyridine or the like. Examples of the solvents include halogenated hydrocarbons such as methylene chloride, chlorobenzene and the like. Furthermore, for facilitation of the reaction, a catalyst such as a tertiary amine, a quaternary ammonium salt and the like can also be used. The reaction temperature is usually from 0 to 40° C., and the reaction time ranges from several minutes to 5 hours.

The melting method may be a method using a diphenyl carbonate in which a dihydric phenol component and the diphenyl carbonate in a predetermined proportion are stirred while being heated in an inert gas atmosphere, and the generated alcohols or phenols are distilled off. The reaction temperature varies according to the boiling point of the generated alcohols or phenols, or the like, but is usually from 120 to 300° C. The reaction can be completed while distilling off the generated alcohols or phenols by reducing a pressure from an early stage of the reaction. Furthermore, in order to facilitate the reaction, a commonly used catalyst for an ester exchange reaction can also be used.

The molecular weight of the polycarbonate according to the present invention is preferably from 10,000 to 50,000 and more preferably from 15,000 to 35,000, in terms of viscosity average molecular weight (M). Polycarbonate having the above viscosity average molecular weight is preferable because sufficient strength can be obtained, and the melt fluidity at the time of molding is excellent.

As needed, a stabilizer such as a phosphite ester, a phosphoric ester, a phosphonic ester or the like, a flame retardant such as tetrabromobisphenol A, a low molecular weight polycarbonate of tetrabromobisphenol A, decabromodiphenol or the like, a colorant, a lubricant and the like can be added to the polycarbonate according to the present invention in such an amount that the object of the present invention is not impaired.

The thickness of the polycarbonate sheet according to the present invention is usually from 0.1 to 4.9 mm, preferably from 0.2 to 4 mm, and further preferably from 0.3 to 3 mm. When the sheet is too thick, a display panel may become too heavy and may fail to reduce the size or weight of equipments provided with the display panel. When the sheet is too thin, the strength of the display panel may be lowered and breakage thereof may be caused during the use.

The polycarbonate sheet according to the present invention, being composed of the above polycarbonate, may be made into the form of a sheet by various known methods. Usually, the above polycarbonate is melt-extruded by using an extruder and extruded into the form of a sheet to obtain a transparent sheet.

(Window Material for a Display)

The window material for a display of the present invention contains at least two layers of the above biaxially stretched polyester sheets, wherein one of the polyester sheets is disposed as an outer layer of the display surface when it is used as a window material for a display. Using only one layer of the above biaxially stretched polyester sheet is not preferable, since the rigidity of the window material may be insufficient, and bending or warpage may occur after the production of the window material. The biaxially stretched polyester sheets may be laminated directly to each other, or may be disposed so as to sandwich another layer. An adhesive may be used or may not be used for lamination. By laminating the biaxially stretched polyester sheets, it becomes possible to apply various kinds of treatments to the sheets. For example, the surface of the sheet can be subjected to various kinds of processes. A variety of properties can be imparted according to usage, for example, facilitation of adhesion with other layers, application of printing ink, suppression of static electricity or the like.

The window material for a display of the present invention has two or more layers of the biaxially stretched polyester sheet, wherein the biaxially stretched sheet is preferably disposed as the outer layer of the window material for a display and the aforementioned layer of a resin other than polyester is preferably included as an inner layer. It is further preferable that the layer of a resin other than polyester is a polycarbonate sheet, since the material has excellent transparency and is capable of being subjected to a punching processing. That is, it is necessary that the window material for a display of the present invention has a biaxially stretched polyester sheet being disposed as the outer surface of the display (outer surface of the window material), and preferably is in the form of a lamination in which a biaxially stretched polyester sheet, a polycarbonate sheet and a biaxially stretched polyester sheet are laminated in this order. With such a structure, a window material having excellent properties as the window material for a display can be obtained, since the polycarbonate sheet can be protected by the biaxially stretched polyester sheet having high strength, while a high degree of transparency can be obtained by the polycarbonate sheet.

The window material for a display of the present invention has at least one of the biaxially stretched polyester sheets disposed as the outer layer of the display surface of a display, when the material is used as a window material for a display. By doing so, the display surface gets fewer scratches even when pressure is applied from the outside, and the window material can be used over a long period of time. The scratch hardness of the biaxially stretched polyester sheet as an outer layer of the window material for a display, i.e., an index of the strength, as measured according to a pencil hardness test (at room temperature, 1 kg load) by using a pencil scratch tester, is usually H or more, preferably 2H or more and further preferably 3H or more. The pencil hardness test was conducted in accordance with JIS-K5600-5-4: 1999, under a load of 1 kg. The window material of the present invention also exhibits excellent effects in a steel wool test in which the scratches are visually measured which occur when a load is applied from above on a #0000 steel wool. No scratch is usually observed under a load of 500 g, and preferably after undergoing 15 reciprocations under a load of 1 kg.

The thickness of the window material for a display of the present invention varies according to the kind or usage of the display, but is from 0.3 to 5 mm, preferably 0.4 mm or more and 3 mm or less, and particularly preferably 0.5 mm or more and 2 mm or less. When the thickness is in the above range, the window material having high transparency, excellent impact resistance and reduced weight, and thereby being superior as the display panel can be obtained.

The total light transmittance of the window material for a display of the present invention (measured by NDH-2000, a product of Nippon Denshoku Industries Co., Ltd.) is from 80 to 99.5%, preferably from 85 to 99.5% and further preferably from 95 to 99.5%. When the total light transmittance is too low, the display may become so dark that it may become difficult to view the characters or graphics, when the window material is used for the display panel.

The window material for a display of the present invention is capable of resisting the impact applied during the punching processing, which is usually carried out for the production of a window material for a display, or the impact from the outside during usage. The bending modulus of elasticity of the window material for a display of the present invention is from 2,500 to 7,000 MPa, preferably from 3,000 to 6,000 MPa and further preferably from 3,800 to 5,000 MPa. Further, a bending strength is from 50 to 100 MPa, preferably from 60 to 90 MPa and further preferably from 70 to 85 MPa. When the bending modulus of elasticity and the bending strength are within the above ranges, the material may have a high degree of mechanical strength and can resist the impact from the outside. The bending modulus of elasticity and the bending strength are measured in accordance with ASTM D790, where the values are at a span of 50 mm and a bending rate of 50 mm/min.

The window material for a display of the present invention is obtained by subjecting the above lamination of films or sheets to a cutting or grinding process to make into the size and the shape of a window of a display panel. The process is usually conducted by cutting with a circular saw, heat rays, lasers or the like; routering with a metal blade; or punching with a mold or the like. In order to avoid the problems that occur during the process, such as a rough cutting surface, a maximum impact strength in a high-speed impact test is required to be at least 1 kN, and particularly preferably 1.5 kN or more. The method of conducting the high-speed impact test is as follows.

A lamination of films or sheets is cut to prepare the test pieces in the form of a square with the size of 50 mm×50 min (lengthwise and crosswise), and the test pieces and a high-speed impact tester (horizontal slide type) are left in a room at 23° C. for 2 hours. Thereafter, in a room at 23° C., one of the test pieces is put on a support having a diameter of 3.0 inches, and a striker having a diameter of ½ inch with a round tip is slided horizontally to the test piece to collide against the test piece at an impact velocity of 3.0 m/sec. The operation was repeated three times and a maximum impact strength (kN) was calculated from the average value of these absorption energies.

Further, the fracture morphology of the sample of the window material for a display of the present invention after the high-speed impact test is ductile. The fracture morphology was determined by observing the fragments of the test piece after the impact at an impact velocity of 3.0 m/sec as described above. Ductile refers to the condition where the longest distance of the direct distance of a crack from the center of impact of the striker is less than 20 mm, including the edge of the fragment, and brittle refers to the condition where the longest distance of the direct distance of a crack from the center of impact of the striker is 20 mm or more, including the edge of the fragment.

The punching method is a processing method that can be applied to mass production, and is capable of reducing the production cost. In order to employ the punching processing method, however, the material is required to be ductile, since the punching processing method cannot be applied to the material that exhibits brittleness such that the sample thereof after the high-speed impact test breaks into pieces like glass. For that reason, the window material of the present invention preferably comprises a polyester layer or a carbonate layer.

The window material for a display of the present invention has at least two layers of the biaxially stretched polyester sheets, or at least two layers of the biaxially stretched polyester sheets and a layer of a resin other than polyester such as a polycarbonate sheet and the like. These sheets are laminated to each other by various known methods, and usually laminated with an adhesive. Any known adhesive can be used, such as a polyvinyl alcohol-based adhesive, a polyurethane-based adhesive, an acrylic adhesive, a vinyl acetate resin emulsion adhesive and the like. Further, a pressure-sensitive adhesive can also be used, such as a rubber pressure-sensitive adhesive, an acrylic pressure-sensitive adhesive, a silicone-based pressure-sensitive adhesive, a vinyl-based pressure-sensitive adhesive and the like.

The window material for a display of the present invention may contain other layers according to the purposes, and examples thereof include a hard coat layer, an anti-reflection layer, a polarizing layer, an infrared ray shielding layer, an anti-glare layer, an anti-static layer, a surface protecting layer and the like. These layers may have the functions such as changing of the brightness, luminosity or saturation of the display surface, protection of the display surface from electromagnetic waves and the like, according to the application or usage. These layers are usually applied as the outermost surface of the window material for a display, but the layers may also be appropriately disposed in between the biaxially stretched polyester sheets, the polycarbonate sheet, or other resin layers. The thickness of the layers can be appropriately selected to such an extent that the object of the present invention is not impaired. In the case where a hard coat layer is provided, the thicknesses thereof can be selected according to the application, but is usually from 0.5 to 10 μm and preferably from 1 to 3 μm. When the hard coat layer is too thin, sufficient surface hardness may not be obtained, and when the hard coat layer is too thick, cracks may occur due to the impact or the like. Further, the hard coat layer may be disposed on the outer surface of the biaxially stretched polyester sheet disposed as the outermost layer.

Various compounds can be used for the hard coat layer according to the present invention and examples thereof include an acrylic compound, a urethane-based compound, a vinyl chloride-based compound, a melamine-based compound, an organic silicate compound, a silicone-based compound, a metal oxide type compound and the like. Among these compounds, an active ray (e.g., ultraviolet ray) curing type acrylic compound and epoxy-based compound are preferable, from the viewpoint that the surface is easily cured, transparency is excellent, and adhesiveness to the biaxially stretched polyester sheet layer is favorable. The active ray curing type acrylic compound is generally used together with an acrylic oligomer, a photoinitiator, a photosensitizer, a modifier or the like, with the use of a reaction diluent. The acrylic oligomer is a general name of the oligomers having a reactive acrylic group, and includes various kinds of acrylic copolymers, urethane acrylic polymers, epoxy acrylic polymers, polyether acrylic polymers and the like.

The aforementioned layers such as a hard coat layer may be obtained by applying the sheet that has been molded into the form of a sheet prior to the application, with an adhesive or the like, or may be formed by applying the material in the form of a resin onto the layer to be applied. Various kinds of adhesives can be used as the above adhesive, but an ultraviolet-effect adhesive is preferable because of its strong adhesiveness. Various known methods can be adopted for the coating of the hard coat layer, and examples thereof include a reverse coating method, a gravure coating method, a bar cording method, a die coating method or a spray coating method. The coating may be carried out with a tool such as a brush, a knife, a roll, a spray or the like; or by immersion, flow coating, spin coating or the like, without using a tool. Further, the surface of the biaxially stretched polyester sheet layer may also be previously subjected to a so-called easy adhesion treatment, prior to providing a hard coat layer. Various known methods can be adopted for the easy adhesion treatment, and examples thereof include a primer treatment, an organic solvent treatment, an acid alkali solution treatment, a mechanical treatment such as grinding, an active ray irradiation treatment and the like. Examples of the active ray irradiation treatment include an electron beam treatment, an ultraviolet treatment, a radiation treatment (alpha rays, gamma rays and the like), a corona discharge treatment and the like. Among these treatments, a corona discharge treatment is preferable from the viewpoints that the adhesiveness to the biaxially stretched polyester sheet layer is strong and transparency is not affected. This easy adhesion treatment can also be applied to adhesion of the biaxially stretched polyester sheets, and adhesion of the biaxially stretched polyester sheet and a layer of a resin other than polyester.

(Method for Producing a Window Material for a Display)

When the window material for a display of the present invention includes at least two biaxially stretched polyester sheets, or a layer of a resin other than polyester, the window material for a display contains at least two biaxially stretched polyester sheets and a layer of a resin other than polyester such as a polycarbonate sheet. These layers are laminated to each other by applying the aforementioned adhesive between the layers, and then processed into a desired shape as a window material for a display to obtain the window material for a display of the present invention. Various known methods can be applied as the processing method, but a method including cutting by a punching processing is particularly preferable because the method can be conducted at a minimum cost and molding can be performed in a large quantity.

(Usage)

The window material for a display of the present invention can be used as a window material for a display of liquid crystal display devices (LCDs), cathode-ray tube display devices (CRTs), EL display devices, plasma display devices (PDPs), personal data assistants (PDAs), projection display devices or display panels of measuring instruments. Specifically, the window material of the present invention is suitably used for personal computers, televisions, digital cameras, video cameras, cellular phones and the like. For example, providing a cellular phone with the window material for a display of the present invention as the display surface is preferable because the cellular phone may become thinner and lighter than ever, the characters or graphics displayed in the display portion are clear, and the resistance against the pressure or scratch from the outside is strong.

### EXAMPLES

The present invention will now be illustrated with reference to Examples. However, the present invention is not restricted to these Examples. Evaluations were made of rigidity (bending modulus of elasticity, bending strength), high-speed impact properties (high-speed impact strength, fracture type), scratch resistance (pencil hardness test) and transparency (total light transmittance), in the manner described as follows at room temperature (23° C.). The results are shown in Table 1.

Thickness: Measured according to a cross-sectional photograph taken by a scanning microscope.

Bending modulus of elasticity: Measured in accordance with ASTM D790.
Span: 50 mm, Bending rate: 50 mm/min

Bending strength: Measured in accordance with ASTM D790.
Span: 50 mm, Bending rate: 50 mm/min

Maximum impact strength: Measured according to a high-speed impact test method.

Striker diameter: ½ inch, Support diameter: 3.0 inches

Fracture morphology: Fracture morphology was visually observed after completion of a test according to a high-speed impact test method. A sample evaluated as ductile was indicated as O and a sample evaluated as brittle was indicated as x, according to the following criteria.

Ductile: Longest distance of the direct distance of a crack from the center of impact of the striker is less than 20 mm.

Brittle: Longest distance of the direct distance of a crack from the center of impact of the striker is 20 mm or more.

Scratch Test:

(1) A pencil hardness test was conducted in accordance with JIS-K5600-5-4:1999 under a load of 1 kg.

(2) An anti-steel wool test was carried out.

Abrasion: Tip 45R, 20×20×30 mm

Steel wool: #0000

Stroke: 100 mm

Number of times of reciprocation: 15 times

Reciprocation rate: 33 times/min

Load: 1 kg

Total light transmittance: The total light transmittance % across all light wavelengths was measured.

### Example 1

A terephthalic acid and ethylene glycol were subjected to condensation polymerization to obtain pellets of polyethylene terephthalate having an intrinsic viscosity of 0.65 dl/g. The resulting pellets were dried, put into an extruder and melt-extruded at 285° C., discharged from a T-type nozzle in the form of a sheet, and cooled down to 70° C. with a cooling roll to obtain a sheet having a thickness of 3,400 μm. Subsequently, the resulting sheet was introduced into a tenter for stretching in the transverse direction, preheated in an atmosphere of 125° C. for 10 seconds, and then stretched in the transverse direction by a stretch ratio of 1.4 times at a stretching rate of 480%/min. The sheet was further stretched in a transverse direction by a stretch ratio of 2.7 times at a stretching rate of 1,300%/min at an atmosphere of 95° C. without cooling, and a sheet that was two-stage stretched in the transverse direction was obtained.

The obtained sheet was preheated with a roll at 85° C. and stretched in the machine direction by a stretch ratio of 4.8 times at a stretching rate of 8,000%/min, while the temperature of the sheet was maintained at 125° C. by infrared heating. The sheet was aged in an atmosphere of 200° C. for 5 seconds, then cooled, and a biaxially stretched polyethylene terephthalate sheet having a thickness of 188 μm was obtained.

Five of the above sheets were prepared and laminated to each other by applying a urethane-based thermal adhesive between the layers to obtain a window material for a display having a thickness of 980 μm (rounded off to the nearest tenth in Table 1).

The obtained window material for a display was tested in accordance with the evaluation methods described above. The results shown in Table 1 were obtained.

### Example 2

Polycarbonate (molecular weight: 27,000, CALIBRE 300-4, a product of Sumitomo Dow Limited) was melt-extruded at 280° C. by a melt-extruder equipped with a T-die to obtain a non-stretched sheet of polycarbonate having a thickness of 380 μm.

Both sides of the obtained non-stretched polycarbonate sheet were coated with a urethane-based thermal adhesive. Two sheets of the biaxially stretched polyethylene terephthalate sheet having a thickness of 188 μm as prepared in Example 1 were laminated onto one coated side of the polycarbonate sheet, and one sheet of the biaxially stretched polyethylene terephthalate sheet was laminated onto the other side, to obtain a window material for a display.

The obtained window material for a display was tested in accordance with the same evaluation methods used in Example 1. The results shown in Table 1 were obtained.

### Example 3

Three sheets of the biaxially stretched polyethylene terephthalate sheet having a thickness of 188 μm obtained in Example 1 were prepared. One side of each of two of these sheets was subjected to an easy adhesion treatment by a corona discharge method, and a hard coat layer of an ultraviolet curing type acryl resin having a thickness of 3 μm was formed thereon, respectively. A urethane-based adhesion was applied on both sides of the remaining biaxially stretched polyethylene terephthalate sheet, and the above two biaxially stretched polyethylene terephthalate sheets with a hard coat layer were laminated onto the each side of the sheet with the urethane-based adhesion, respectively, in such a manner that the hard coat layers were on the outer side. A window material for a display having a structure of “hard coat layer/polyethylene terephthalate layer composed of three layers/hard coat layer” was then obtained. The thus obtained window material for a display was subjected to the same evaluation methods used in Example 1. The results shown in Table 1 were obtained.

### Example 4

A window material for a display was obtained in the same manner as in Example 3, except that one out of the three biaxially stretched polyethylene terephthalate sheet was replaced with a non-stretched polycarbonate sheet having a thickness of 380 μm obtained in Example 2.

The obtained window material for a display was subjected to the same evaluation methods used in Example 1. The results shown in Table 1 were obtained.

### Comparative Example 1

A non-stretched polycarbonate sheet having a thickness of 1.0 mm was obtained in the same manner as in Example 2, wherein the brand of the polycarbonate was the same as the one used in Example 2. A test was carried out in accordance with the same evaluation methods used in Example 1. The results shown in Table 1 were obtained.

### Comparative Example 2

An acrylic resin (molecular weight: 1,100,000) was melt-extruded into the form of a sheet, at 270° C. by a melt-extruder equipped with a T-die. Subsequently, the resulting sheet was closely contacted onto a casting roll having the surface temperature being adjusted to 18° C., and cooled down rapidly to obtain a non-stretched sheet having a thickness of 1.0 mm.

The obtained non-stretched sheet was tested in accordance with the same evaluation methods used in Example 1. The results shown in Table 1 were obtained.

### Comparative Example 3

A non-stretched polyethylene terephthalate sheet was obtained in the same manner as in Example 1, using the same kind of polyethylene terephthalate pellets as the pellets used in Example 1, except that the thickness of the sheet after being molded was changed to 0.8 mm.

The obtained non-stretched sheet was tested in accordance with the same evaluation methods used in Example 1. The results shown in Table 1 were obtained.

### Comparative Example 4

A polycarbonate sheet having a hard coat layer was obtained in the same manner as in Example 3, by providing hard coat layers on both sides of the non-stretched polycarbonate sheet obtained in Comparative Example 1.

The obtained sheet was tested in accordance with the same evaluation methods used in Example 1. The results shown in Table 1 were obtained.

### Comparative Example 5

An acrylic resin sheet having a hard coat layer was obtained in the same manner as in Example 3, by providing hard coat layers on both sides of the non-stretched acrylic resin sheet obtained in Comparative Example 2.

The obtained sheet was tested in accordance with the same evaluation methods used in Example 1. The results shown in Table 1 were obtained.

TABLE 1

| | | | | High-speed Impact | | | | |
|---|---|---|---|---|---|---|---|---|
| | | Rigidity | | Property | | | | |
| | | Bending | | Maximum | | Scratch Resistance | | Transparency |
| | | modulus of | Bending | impact | Fracture | Pencil | Anti-steel | Total light |
| | Thickness | elasticity | strength | strength | morphology | hardness test | wool test | transmittance |
| Test Items | mm | MPa | MPa | kN | — | — | — | % |
| Example 1 | 1.0 | 4400 | 78 | 2.0 | Ductile | 2H~3H | No scratch | 91 |
| Example 2 | 0.9 | 4320 | 76 | 2.3 | Ductile | 2H~3H | No scratch | 91 |
| Example 3 | 0.6 | 4400 | 78 | 2.0 | Ductile | 4H | No scratch | 91 |
| Example 4 | 0.8 | 4320 | 76 | 2.3 | Ductile | 4H | No scratch | 91 |
| Comparative | 1.0 | 2400 | 52 | 1.92 | Ductile | HB | No scratch | 92 |
| Example 1 | | | | | | | | |
| Comparative | 1.0 | 3600 | 64 | 0.14 | Brittle | 4H | With scratch | 93 |
| Example 2 | | | | | | | | |
| Comparative | 0.8 | 2400 | 70 | 0.6 | Ductile | F | No scratch | 82 |
| Example 3 | | | | | | | | |
| Comparative | 1.1 | 2400 | 52 | 1.92 | Ductile | 4H | No scratch | 92 |
| Example 4 | | | | | | | | |
| Comparative | 1.1 | 3600 | 64 | 0.14 | Brittle | 4H | No scratch | 93 |
| Example 5 | | | | | | | | |

1. A window material for a display, comprising at least two biaxially stretched polyester sheets, wherein one of the sheets is disposed as an outer layer of a display surface.

2. The window material for a display of claim 1, having a thickness of from 0.3 to 5 mm.

3. The window material for a display of claim 1, having a total light transmittance of from 80 to 99.5%.

4. The window material for a display of claim 1, further comprising a laminated layer of a resin other than polyester.

5. The window material for a display of claim 4, wherein the layer of a resin other than polyester is a polycarbonate sheet.

6. The window material for a display of claim 5, wherein a biaxially stretched polyester sheet, a polycarbonate sheet and a biaxially stretched polyester sheet are laminated in this order from the outer side of the display surface.

7. The window material for a display of claim 1, having a bending strength of from 50 to 100 MPa.

8. The window material for a display of claim 1, having a bending modulus of elasticity of from 2,500 to 7,000 MPa.

9. The window material for a display of claim 1, wherein the maximum impact strength of the window material as measured in a high-speed impact test is 1 kN or more.

10. The window material for a display of claim 1, wherein the fracture morphology after impact in a high-speed impact test is ductile.

11. The window material for a display of claim 1, wherein the scratch hardness as measured in a pencil hardness test (JIS-K5600-5-4:1999, 1 kg load) of the outer layer biaxially stretched polyester sheet is 2H or more.

12. The window material for a display of claim 1, wherein the biaxially stretched polyester sheet is a biaxially stretched polyethylene terephthalate sheet.

13. The window material for a display of claim 1, further comprising at least one layer selected from a hard coat layer, an anti-reflection layer, a polarizing layer, an infrared ray shielding layer, an anti-glare layer, an anti-static layer, an electromagnetic wave shielding layer, an anti-fogging layer and a surface protecting layer.

14. The window material for a display of claim 13, wherein the hard coat layer is further disposed at a further outer side than the outer layer biaxially stretched polyester sheet.

15. The window material for a display of claim 1, wherein the window material is used for a device selected from the group consisting of a liquid crystal display device (LCD), a cathode-ray tube display device (CRT), an EL display device, a plasma display device (PDP), a projection display device and a display panel for a measuring instrument.
